(19) United States
(12) Patent Application Publication
(10) Pub. No.: US 2007/0116548 A1
(43) Pub. Date: May 24, 2007

(54) Fork-type pallet-lifting device

(76) Inventor: David A. Cooper, Horsham (GB)

Correspondence Address: DONALD R. SCHOONOVER, 4211 ROLLING HILLS DRIVE, NIXA, MO, 65714-8771, US

(21) Appl. No.: 11/281,139

(22) Filed: Nov. 18, 2005

(51) Int. Cl. B66F 9/18

(52) U.S. Cl. 414/619

(57) ABSTRACT

A fork-type pallet-lifting device having frame means with a steering wheel-mounting mechanism and fork-supporting means a steering wheel unit mounted to the steering wheel-mounting mechanism, a fork unit with opposing first and second fork elements mounted to the fork-supporting means, fork-displacing means structured to selectively and separately allow lateral displacement of the first and second fork elements relative to each other, hydraulic means with supporting wheel means, a hydraulic motor, and a linkage arrangement structured to suspend the first and second fork elements at a selected elevation above an underlying supporting surface, and control means including a hydraulic motor, and a main handle and a release mechanism for controlling the hydraulic motor.

### BACKGROUND OF THE INVENTION

1. Field of the Invention

The present invention relates to the general art of material and article handling, and to the particular field of hoists or loading equipment with means for additional movement.

2. Description of the Related Art

Material and articles are often handled by a vehicle such as a fork lift truck. Such trucks generally have a mast to which forks are movably attached. These forks generally move up and down in a vertical direction to move material, pallets and the like from one level to another.

However, there are many instances when simple vertical movement of the forks is not sufficient. For example, if the vehicle cannot be maneuvered into a certain orientation with respect to the load, the forks may not be properly oriented. Still further, some loads, such as pallets, may not fit on forks that are oriented at a specific distance with respect to each other. In some instances, a pallet may be loaded in an asymmetric manner, in which case, a fork lift that has symmetrically oriented forks may not be as efficient as possible.

Therefore, there is a need for a fork lift having forks that can be moved in a horizontal direction with respect to each other. There is also a need for a fork lift wherein the length of the forks is adjustable.

### PRINCIPAL OBJECTS OF THE INVENTION

It is a main object of the present invention to provide a fork lift having forks that can be moved in a horizontal direction with respect to each other.

It is another object of the present invention to provide a fork lift having forks wherein the length of the forks is adjustable.

### SUMMARY OF THE INVENTION

The improvements of the fork-type pallet-lifting device of the present invention comprise frame means, a steering wheel unit, a fork unit, fork-displacing means, hydraulic means, and control means.

The frame means includes a steering wheel-mounting mechanism having a vertically oriented axis, a fork-supporting means, and a horizontally oriented crossbar with an upper surface and with two sets of vertically oriented throughbores wherein the fork-supporting means includes: a horizontally oriented support element, first and second vertically oriented supporting elements suspended from the horizontally oriented support element, the first and second vertically oriented supporting elements being fixedly connected to the fork front end of a respective one of hereinafter described first and second fork elements, each of the vertically oriented supporting elements including a horizontally oriented plate having at least one throughbore, each plate being spaced adjacently to the upper surface of the crossbar wherein the at least one throughbore is alignable with a selected throughbore of a respective one of the two sets of throughbores, and a pair of pins, each removably insertable through the at least one throughbore of a respective one of the plates and through an aligned selected throughbore of a respective one of the two sets of throughbores to thereby selectively lock the lateral spacing of the hereinafter described first and second fork elements relative to each other.

The steering wheel unit is mounted to the steering wheel-mounting mechanism to pivot about the vertically oriented axis.

The fork unit, which is mounted to the fork-supporting means, includes opposing first and second fork elements, each having a fork front end and a fork rear end, wherein each of the opposing first and second fork elements includes a first fork portion, a second fork portion, and fastening means, and wherein the first and second fork portions are telescopically slidable longitudinally relative to each other, and wherein the fastening means selectively fixes the respective overall length of the first fork portion in combination with the second fork portion.

The fork-displacing means, which is mounted to the frame means, is structured to selectively and separately allow lateral displacement of the first and second fork elements relative to each other. The fork-displacing means includes the first and second vertically oriented supporting elements being slidably mounted on the horizontally oriented support element to thereby allow the first and second fork elements to be horizontally and laterally displaced relative to each other. The fork-displacing means further includes a pair of displacing handles, one mounted on each of the first and second vertically oriented supporting elements.

The hydraulic means, which is mounted to the frame means, includes supporting wheel means having opposing supporting wheels which, in cooperation with the steering wheel unit, is structured to selectively and vertically displace and suspend the first and second fork elements at a selected elevation above an underlying supporting surface; a horizontally oriented axle; a hydraulic motor structured to selectively rotate the horizontally oriented axle, and a linkage arrangement connecting the horizontally oriented axle to the opposing supporting wheels. The linkage arrangement includes a pair of first lever arms, each having a proximal end and a distal end; a pair of second lever arms, each having a proximal end and a distal end; a pair of third lever arms, each having a proximal end and a distal end; a pair of fourth lever arms, each having a proximal end and a distal end; and a pair of elongate links, each having a proximal end and a distal end, and each including a first link portion, a second link portion, and fastening means wherein the first and second link portions are slidable longitudinally relative to each other, and wherein the fastening means selectively fixes the respective overall length of the first link portion in combination with the second link portion, and wherein the proximal end of the first lever arm is longitudinally slidable along, but not radially pivotal about, the horizontally oriented axle; the distal end of the first lever arm is fixedly secured to the proximal end of the second lever arm, the distal end of the first lever arm and the proximal end of the second lever arm are pivotally connected to the frame means, the distal end of the third lever arm is fixedly secured to the proximal end of the fourth lever arm, the distal end of the third lever arm and the proximal end of the fourth lever arm are pivotally secured to a respective one of the first and second fork elements, each of the opposing supporting wheels is rotationally secured to the distal end of a respective one of the fourth lever arms, the relative lengths of the first and second lever arms and the angular relationship therebetween, and the relative lengths of the third and fourth lever arms and the angular relationship therebetween and relative to the lengths and angular relationship of the first and second lever arms are dimensioned such that the elevation of the fork front ends of the first and second fork elements above an underlying supporting surface is always substantially equal to the elevation of the fork rear ends of the first and second fork elements above the underlying supporting surface, and the proximal end of each of the elongate links is pivotally connected to the distal end of a respective one of the second lever arms and the distal end of each of the elongate links is pivotally connected to the proximal end of a respective one of the third lever arms.

The control means, which controls the hydraulic motor, includes a main handle pivotally mounted to the steering wheel-mounting mechanism about a horizontally oriented axis, the main handle being structured to activate the hydraulic motor, a biasing mechanism structured to bias the main handle to an upright position, and a release mechanism structured to cause the hydraulic motor to allow the horizontally oriented axle to freely rotate such that the first and second fork elements return to their lowermost positions.

### BRIEF DESCRIPTION OF THE DRAWING FIGURES

FIG. 1 is a side elevational view of a pallet-lifting apparatus in accordance with the present invention.

FIG. 2 is a top plan view of the pallet-lifting apparatus.

FIG. 3 is an end elevational view of the pallet-lifting apparatus.

FIG. 4 is an enlarged and fragmentary, side elevational and cross-sectional view of a vertically oriented supporting element, a horizontally oriented plate, and a pin of the pallet-lifting apparatus.

FIG. 5 is a fragmentary top plan view of the pallet-lifting apparatus showing first and second fork elements thereof displaced inwardly toward each other to accommodate a narrow skid, and also showing the first and second fork elements retracted to accommodate a short skid.

FIG. 6 is a fragmentary top plan view of the pallet-lifting apparatus showing the first and second fork elements thereof displaced outwardly away from each other to accommodate a wide skid, and also showing the first and second fork elements extended to accommodate a long skid.

FIG. 7 is a fragmentary side elevational view with parts removed for purposes of clarity, showing the pallet-lifting apparatus lowered relative to an underlying supporting surface.

FIG. 8 is a fragmentary side elevational view with parts removed for purposes of clarity, showing the pallet-lifting apparatus elevated relative to an underlying supporting surface.

FIG. 9 is an enlarged and fragmentary top plan view with portions cut away to reveal details of a fastening means of one of the fork elements of the pallet-lifting apparatus, in accordance with the present invention.

### DETAILED DESCRIPTION OF THE PREFERRED EMBODIMENT

Other objects, features and advantages of the invention will become apparent from a consideration of the following detailed description and the accompanying drawings.

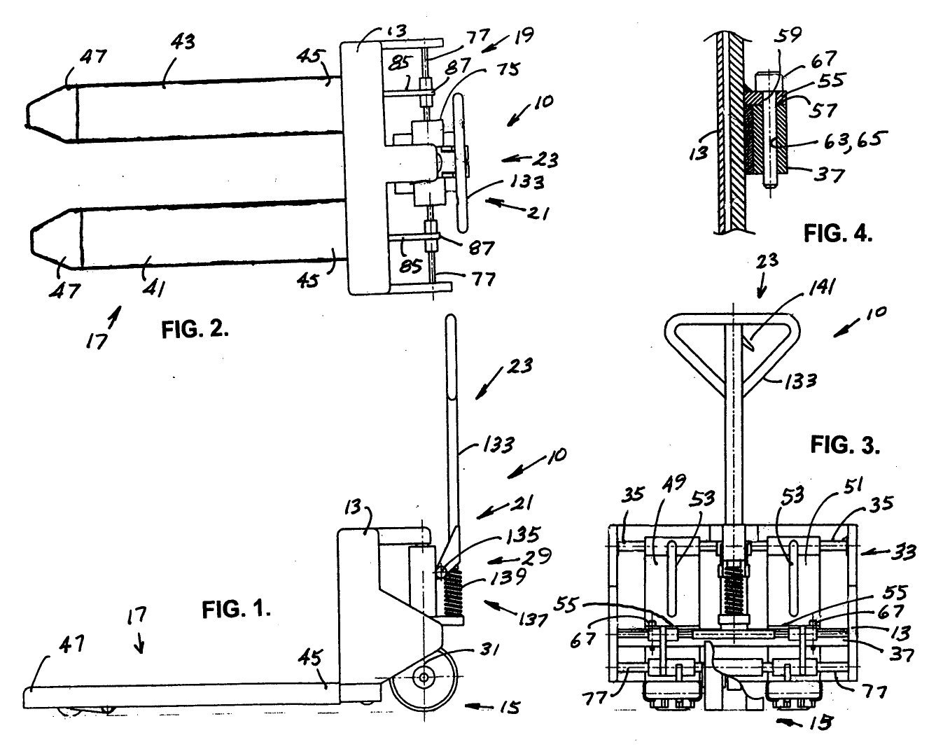

A fork-type pallet-lifting apparatus 10 as shown in FIGS. 1 through 9. The pallet-lifting apparatus 10 includes frame means 13, a steering wheel unit 15, a fork unit 17, fork-displacing means 19, hydraulic means 21, and control means 23.

The frame means 13 includes a steering wheel-mounting mechanism 29 having a vertically oriented axis 31 and a fork-supporting means 33, which includes a horizontally oriented support element 35 and a horizontally oriented crossbar 37. The steering wheel unit 15 is mounted to the steering wheel-mounting mechanism 29 to pivot about the vertically oriented axis 31.

The fork unit 17 is mounted on the fork-supporting means 33 and includes opposing first and second fork elements 41, 43, each having a fork front end 45 and a fork rear end 47. The fork-supporting means 31 includes first and second vertically oriented supporting elements 49, 51, which are suspended from the horizontally oriented support element 35 and which are fixedly connected to the fork front end 45 of a respective one of the first and second fork elements 41, 43.

The fork-displacing means 19 includes the first and second vertically oriented supporting elements 49, 51 being slidably mounted on the horizontally oriented support element 35 to thereby selectively and separately allow horizontal lateral displacement of the first and second fork elements 41, 43 relative to each other. FIGS. 1, 3 and 5 show the first and second fork elements 41, 43 moved inwardly toward each other in order to accommodate a narrow skid, and FIG. 6 shows the first and second fork elements 41, 43 displaced outwardly away from each other in order to accommodate a wide skid. The fork-displacing means 19 includes a pair of displacing handles 53, one mounted on each of the first and second vertically oriented supporting elements 49, 51 for slidably displacing the respective first and second vertically oriented supporting elements 49, 51 horizontally along the horizontally oriented support element 35.

Each of the first and second vertically oriented supporting elements 49, 51 has a horizontally oriented plate 55 spaced adjacently to an upper surface 57 of the crossbar 37. Each of the plates 55 has at least one throughbore 59 that can be aligned with selected ones of corresponding sets of vertically oriented throughbores 63, 65 through the crossbar 37. A pair of pins 67 are removably inserted through bores 59 and through selected ones of the sets of bores 63, 65, to thereby selectively lock the lateral spacing of the first and second fork elements 41, 43 relative to each other.

The hydraulic means 21 is mounted on the frame means 13 and includes supporting wheel means 71 which, in cooperation with the steering wheel unit 15, is structured to suspend the first and second fork elements 41, 43 at a selected elevation above an underlying supporting surface 73. The hydraulic means 21 is structured to selectively and vertically displace the first and second fork elements 41, 43 relative to the underlying supporting surface 73.

The hydraulic means 21 includes a hydraulic motor 75, that is structured to selectively rotate a horizontally oriented axle 77, the supporting wheel means 71 which includes opposing supporting wheels 81, and a linkage arrangement 83. The linkage arrangement 83 includes a pair of first lever arms 85, each having a proximal end 87 and a distal end 89, and a pair of second lever arms 91, each having a proximal end 93 and a distal end 95. The distal end 89 of each first lever arm 85 is fixedly secured to the proximal end 93 of the respective second lever arm 91. The proximal end 87 of each first lever arm 85 is longitudinally slidable along, but not radially pivotal about, the horizontally oriented axle 77. For example, the cross-section of the axle 77 is non-circular or ribbed, or has any other cross-sectional profile that prevents rotation of the first lever arms 85 relative to the axle 77. The distal end 89 of each first lever arm 85 and the proximal end 93 of the respective second lever arm 91 are pivotally connected to the frame means 13 about an axis 97.

The linkage arrangement 83 also includes a pair of third lever arms 101, each having a proximal end 103 and a distal end 105, and a pair of fourth lever arms 107, each having a proximal end 109 and a distal end 111. The distal end 105 of each third lever arm 101 is fixedly secured to the proximal end 109 of the respective fourth lever arm 107. The distal end 105 of each third lever arm 101 and the respective proximal end 109 of the fourth lever arm 107 are pivotally secured to a respective one of the first and second fork elements 41, 43 about an axis 113. Each of the opposing supporting wheels 81 is rotationally secured to the distal end 111 of a respective one of the fourth lever arms 107.

The relative lengths of the first and second lever arms 85, 91 and the angular relationship therebetween, and the relative lengths of the third and fourth lever arms 101, 107 and the angular relationship therebetween and relative to the lengths and angular relationship of the first and second lever arms 85, 91, are dimensioned such that the elevation of the fork front ends 45 of the first and second fork elements 41, 43 above the underlying supporting surface 73 is always substantially equal to the elevation of the fork rear ends 47 of the first and second fork elements 41, 43 above the underlying supporting surface 73.

The linkage arrangement 83 further includes a pair of elongate links 115, each having a proximal end 117 and a distal end 119. The proximal end 117 of each of the elongate links 115 is pivotally connected to the distal end 95 of a respective one of the second lever arms 91, and the distal end 119 of each of the elongate links 115 is pivotally connected to the proximal end 103 of a respective one of the third lever arms 101. Each elongate link 115 comprises a first link portion 121 and a second link portion 123 that are slidable longitudinally relative to each other. First fastening means 125, such as a bolt and nut through appropriately spaced throughbores for example, selectively fixes the respective overall length of the elongate links 115.

Each of the first and second fork elements 41, 43 comprises a first fork portion 127 and a second fork portion 129 that are telescopically slidable longitudinally relative to each other. Second fastening means 131 selectively fixes the respective overall length of the first and second fork elements 41, 43. An example of the second fastening means 131 is shown in FIG. 9.

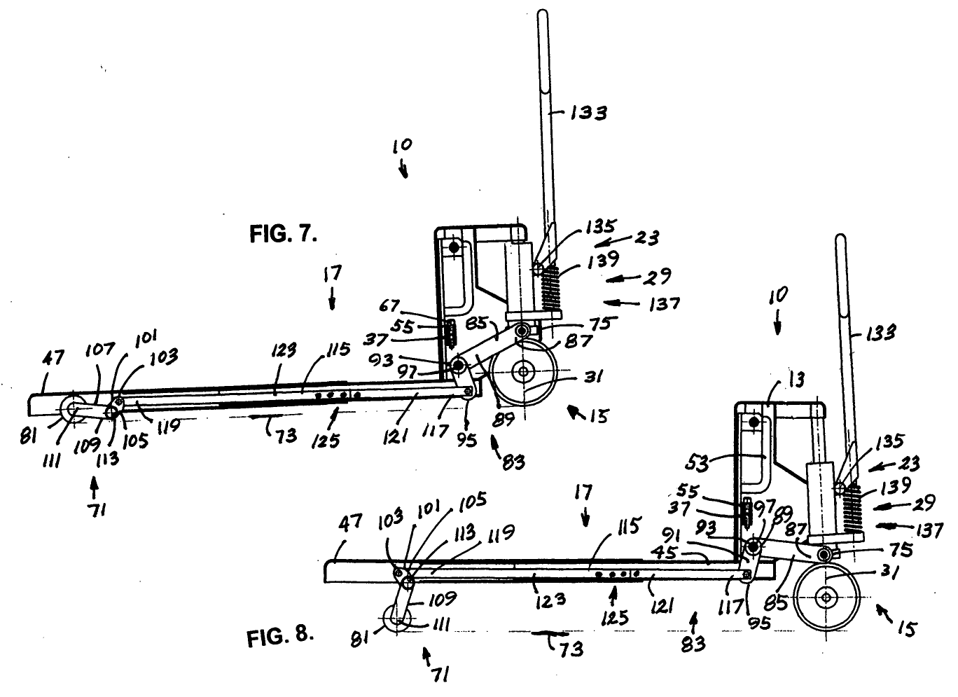

The control means 23 is structured to control the hydraulic means 21 and includes a main handle 133 pivotally mounted to the steering wheel-mounting mechanism 29 about a horizontally oriented axis 135. A biasing mechanism 137, such as a compression coil spring 139, is structured to bias the handle 133 to an upright position, as shown in FIG. 1. The control means 23 includes a release mechanism 141 that is structured to cause the hydraulic motor 75 to allow the horizontally oriented axle 77 to freely rotate such that the first and second fork elements 41, 43 return to their lowermost positions, as shown in FIGS. 1 and 7.

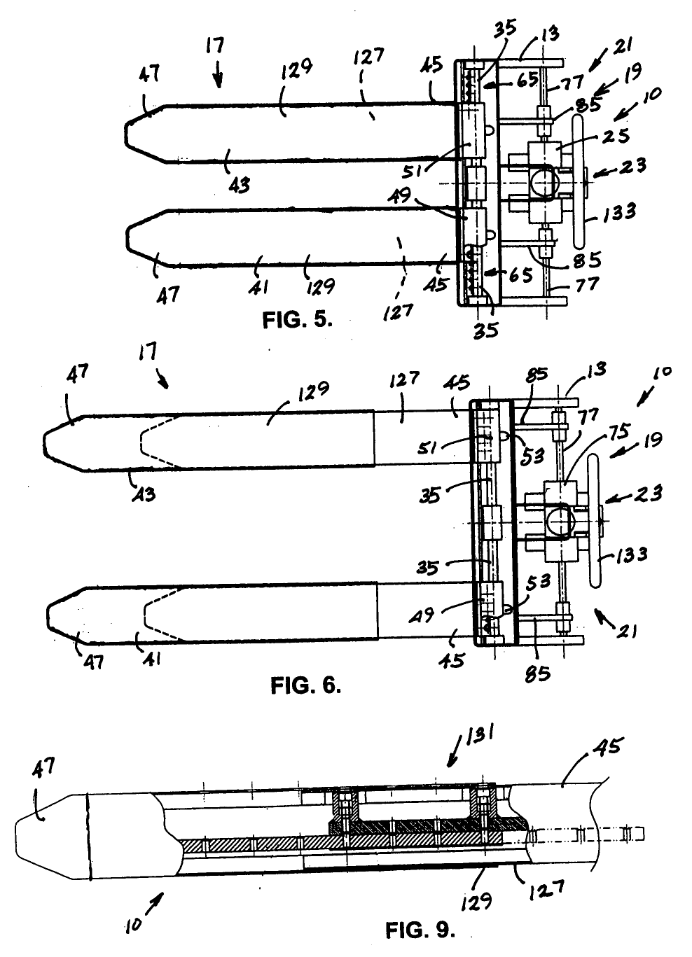

In an application of the present invention, the first and second fastening means 125, 131 are used to adjust the lengths of the elongate links 115 and the lengths of the first and second fork elements 41, 43 to accommodate the lengths of short skids (see FIG. 4) and long skids (see FIG. 5) to be handled by the pallet-lifting apparatus 10. Similarly, the pins 67 are temporarily removed from the bores 59, 63, 65 to adjust the distance between the first and second fork elements 41, 43 by pulling or pushing on the displacing handles 53, thereby sliding the proximal ends 87 of the first lever arms 85 along the axle 77 in order to accommodate the widths of narrow skids (see FIGS. 2, 3 and 5) and wide skids (see FIG. 6) to be handled by the pallet-lifting apparatus 10. With the elevation of the first and second fork elements 41, 43 in their lowermost position (see FIGS. 1 and 7) and using the main handle 133 to steer and maneuver the first and second fork elements 41, 43 into the void of a skid to be handled by the pallet-lifting apparatus 10, the release mechanism 141 is closed, and the main handle 133 is pumped up and down, causing the hydraulic motor 75 to rotate the horizontally oriented axle 77, thereby elevating the first and second fork elements 41, 43 and accordingly lifting the skid clear of the underlying supporting surface 73 (see FIG. 8). After the skid has been relocated as desired, the release mechanism 141 is opened, allowing the first and second skid elements 41, 43 to return to their lowermost positions. The main handle 133 is then used to pull the pallet-lifting apparatus 10 from the void of the skid.

It is to be understood that while certain forms of the present invention have been illustrated and described herein, it is not to be limited to the specific forms or arrangements of parts described and shown.

What is claimed and desired to be covered by Letters Patent is as follows:

1. A fork-type pallet-lifting device, comprising:
(a) frame means, including a steering wheel-mounting mechanism having a vertically oriented axis and a fork-supporting means;
(b) a steering wheel unit mounted to the steering wheel-mounting mechanism to pivot about the vertically oriented axis;
(c) a fork unit mounted to the fork-supporting means, the fork unit including opposing first and second fork elements, each having a fork front end and a fork rear end;
(d) fork-displacing means mounted to the frame means, the fork-displacing means structured to selectively and separately allow lateral displacement of the first and second fork elements relative to each other;
(e) hydraulic means mounted on the frame means; the hydraulic means including supporting wheel means structured to suspend the frame means a selected elevation above an underlying supporting surface;
the hydraulic means including a hydraulic motor structured to selectively and vertically displace the first and second fork elements relative to the underlying supporting surface; and
(f) control means for controlling the hydraulic motor, the control means wherein the control means includes a handle pivotally mounted to the steering wheel-mounting mechanism about a horizontally oriented axis; the control means including a release mechanism for selectively releasing a hydraulic pressure within the hydraulic motor.

2. A fork-type pallet-lifting device as described in claim 1, wherein the fork-supporting means includes:
(a) a horizontally oriented support element, and
(b) first and second vertically oriented supporting elements suspended from the horizontally oriented support element, the first and second vertically oriented supporting elements being fixedly connected to the fork front end of a respective one of the first and second fork elements.

3. A fork-type pallet-lifting device as described in claim 2, wherein the fork-displacing means includes the first and second vertically oriented supporting elements being slidably mounted on the horizontally oriented support element to thereby allow the first and second fork elements to be horizontally and laterally displaced relative to each other.

4. A fork-type pallet-lifting device as described in claim 3, wherein the fork-displacing means further includes a pair of displacing handles, one mounted on each of the first and second vertically oriented supporting elements.

5. A fork-type pallet-lifting device as described in claim 3, wherein:
(a) the frame means includes a horizontally oriented crossbar with an upper surface and with two sets of vertically oriented throughbores;
(b) each of the vertically oriented supporting elements includes a horizontally oriented plate having at least one throughbore, each plate being spaced adjacently to the upper surface of the crossbar wherein the at least one throughbore is alignable with a selected throughbore of a respective one of the two sets of throughbores; and
(c) a pair of pins, each removably insertable through the at least one throughbore of a respective one of the plates and through an aligned selected throughbore of a respective one of the two sets of throughbores to thereby selectively lock the lateral spacing of the first and second fork elements relative to each other.

6. A fork-type pallet-lifting device as described in claim 1, wherein the hydraulic means includes supporting wheel means which, in cooperation with the steering wheel unit, is structured to selectively and vertically displace and suspend the first and second fork elements relative to an underlying supporting surface.

7. A fork-type pallet-lifting device as described in claim 1, wherein the hydraulic means includes:
(a) the supporting wheel means having opposing supporting wheels;
(b) a horizontally oriented axle;
(c) a hydraulic motor structured to selectively rotate the horizontally oriented axle; and
(d) a linkage arrangement connecting the horizontally oriented axle to the opposing supporting wheels.

8. A fork-type pallet-lifting device as described in claim 7, wherein the linkage arrangement includes:
(a) a pair of first lever arms, each having a proximal end and a distal end;
(b) a pair of second lever arms, each having a proximal end and a distal end;
(c) a pair of third lever arms, each having a proximal end and a distal end;
(d) a pair of fourth lever arms, each having a proximal end and a distal end; and
(e) a pair of elongate links, each having a proximal end and a distal end; and
(f) wherein
(1) the proximal end of the first lever arm is longitudinally slidable along, but not radially pivotal about, the horizontally oriented axle,
(2) the distal end of the first lever arm is fixedly secured to the proximal end of the second lever arm,
(3) the distal end of the first lever arm and the proximal end of the second lever arm are pivotally connected to the frame means,
(4) the distal end of the third lever arm is fixedly secured to the proximal end of the fourth lever arm,
(5) the distal end of the third lever arm and the proximal end of the fourth lever arm are pivotally secured to a respective one of the first and second fork elements,
(6) each of the opposing supporting wheels is rotationally secured to the distal end of a respective one of the fourth lever arms,
(7) the relative lengths of the first and second lever arms and the angular relationship therebetween, and the relative lengths of the third and fourth lever arms and the angular relationship therebetween and relative to the lengths and angular relationship of the first and second lever arms are dimensioned such that the elevation of the fork front ends of the first and second fork elements above an underlying supporting surface is always substantially equal to the elevation of the fork rear ends of the first and second fork elements above the underlying supporting surface, and
(8) the proximal end of each of the elongate links is pivotally connected to the distal end of a respective one of the second lever arms and the distal end of each of the elongate links is pivotally connected to the proximal end of a respective one of the third lever arms.

9. A fork-type pallet-lifting device as described in claim 8, wherein each elongate link includes:
(a) a first link portion;
(b) a second link portion; and
(c) fastening means; and
(d) wherein the first and second link portions are slidable longitudinally relative to each other, and wherein the fastening means selectively fixes the respective overall length of the first link portion in combination with the second link portion.

10. A fork-type pallet-lifting device as described in claim 1, wherein each of the first and second fork elements includes:
(a) a first fork portion;
(b) a second fork portion; and
(c) fastening means; and
(d) wherein the first and second fork portions are telescopically slidable longitudinally relative to each other, and wherein the fastening means selectively fixes the respective overall length of the first fork portion in combination with the second fork portion.

11. A fork-type pallet-lifting device as described in claim 1, wherein the control means includes:
(a) a main handle pivotally mounted to the steering wheel-mounting mechanism about a horizontally oriented axis, the main handle being structured to activate the hydraulic motor; and
(b) a release mechanism structured to cause the hydraulic motor to allow the horizontally oriented axle to freely rotate such that the first and second fork elements return to their lowermost positions.

12. A fork-type pallet-lifting device as described in claim 11, further comprising a biasing mechanism structured to bias the main handle to an upright position.

13. A fork-type pallet-lifting device, comprising:
(a) frame means, including a steering wheel-mounting mechanism having a vertically oriented axis, a fork-supporting means, and a horizontally oriented crossbar with an upper surface and with two sets of vertically oriented throughbores wherein the fork-supporting means includes:
(1) a horizontally oriented support element,
(2) first and second vertically oriented supporting elements suspended from the horizontally oriented support element, the first and second vertically oriented supporting elements being fixedly connected to the fork front end of a respective one of hereinafter described first and second fork elements, each of the vertically oriented supporting elements including a horizontally oriented plate having at least one throughbore, each plate being spaced adjacently to the upper surface of the crossbar wherein the at least one throughbore is alignable with a selected throughbore of a respective one of the two sets of throughbores, and
(3) a pair of pins, each removably insertable through the at least one throughbore of a respective one of the plates and through an aligned selected throughbore of a respective one of the two sets of throughbores to thereby selectively lock the lateral spacing of the hereinafter described first and second fork elements relative to each other.
(b) a steering wheel unit mounted to the steering wheel-mounting mechanism to pivot about the vertically oriented axis;
(c) a fork unit mounted to the fork-supporting means, the fork unit including opposing first and second fork elements, each having a fork front end and a fork rear end; each of the opposing first and second fork elements including:
(1) a first fork portion,
(2) a second fork portion, and
(3) fastening means, and
(4) wherein the first and second fork portions are telescopically slidable longitudinally relative to each other, and wherein the fastening means selectively fixes the respective overall length of the first fork portion in combination with the second fork portion;
(d) fork-displacing means mounted to the frame means, the fork-displacing means structured to selectively and separately allow lateral displacement of the first and second fork elements relative to each other, the fork-displacing means including the first and second vertically oriented supporting elements being slidably mounted on the horizontally oriented support element to thereby allow the first and second fork elements to be horizontally and laterally displaced relative to each other; the fork-displacing means further including a pair of displacing handles, one mounted on each of the first and second vertically oriented supporting elements;
(e) hydraulic means mounted on the frame means; the hydraulic means including:
(1) supporting wheel means having opposing supporting wheels which, in cooperation with the steering wheel unit, is structured to selectively and vertically displace and suspend the first and second fork elements at a selected elevation above an underlying supporting surface,
(2) a horizontally oriented axle,
(3) a hydraulic motor structured to selectively rotate the horizontally oriented axle, and
(4) a linkage arrangement connecting the horizontally oriented axle to the opposing supporting wheels, the linkage arrangement including:
(A) a pair of first lever arms, each having a proximal end and a distal end,
(B) a pair of second lever arms, each having a proximal end and a distal end,
(C) a pair of third lever arms, each having a proximal end and a distal end,
(D) a pair of fourth lever arms, each having a proximal end and a distal end, and
(E) a pair of elongate links, each having a proximal end and a distal end, and each including:
(I) a first link portion,
(ii) a second link portion, and
(iii) fastening means, and
(iv) wherein the first and second link portions are slidable longitudinally relative to each other, and wherein the fastening means selectively fixes the respective overall length of the first link portion in combination with the second link portion, and
(F) wherein
(I) the proximal end of the first lever arm is longitudinally slidable along, but not radially pivotal about, the horizontally oriented axle,
(ii) the distal end of the first lever arm is fixedly secured to the proximal end of the second lever arm,
(iii) the distal end of the first lever arm and the proximal end of the second lever arm are pivotally connected to the frame means,
(iv) the distal end of the third lever arm is fixedly secured to the proximal end of the fourth lever arm,
(v) the distal end of the third lever arm and the proximal end of the fourth lever arm are pivotally secured to a respective one of the first and second fork elements,
(vi) each of the opposing supporting wheels is rotationally secured to the distal end of a respective one of the fourth lever arms,
(vii) the relative lengths of the first and second lever arms and the angular relationship therebetween, and the relative lengths of the third and fourth lever arms and the angular relationship therebetween and relative to the lengths and angular relationship of the first and second lever arms are dimensioned such that the elevation of the fork front ends of the first and second fork elements above an underlying supporting surface is always substantially equal to the elevation of the fork rear ends of the first and second fork elements above the underlying supporting surface, and
(viii) the proximal end of each of the elongate links is pivotally connected to the distal end of a respective one of the second lever arms and the distal end of each of the elongate links is pivotally connected to the proximal end of a respective one of the third lever arms; and
(f) control means for controlling the hydraulic motor, the control means wherein the control means includes a handle pivotally mounted to the steering wheel-mounting mechanism about a horizontally oriented axis; the control means including a release mechanism for selectively releasing a hydraulic pressure within the hydraulic motor, the control means including:
(1) a main handle pivotally mounted to the steering wheel-mounting mechanism about a horizontally oriented axis, the main handle being structured to activate the hydraulic motor,
(2) a biasing mechanism structured to bias the main handle to an upright position, and
(3) a release mechanism structured to cause the hydraulic motor to allow the horizontally oriented axle to freely rotate such that the first and second fork elements return to their lowermost positions.
